(19) United States
(12) Patent Application Publication
(10) Pub. No.: US 2020/0021010 A1
(43) Pub. Date: Jan. 16, 2020

(54) AIR COUPLED SUPERSTRATE ANTENNA ON DEVICE HOUSING

(71) Applicant: QUALCOMM Incorporated, San Diego, CA (US)

(72) Inventors: Yu-Chin OU, San Diego, CA (US); Mohammad TASSOUDJI, San Diego, CA (US)

(21) Appl. No.: 16/035,324

(22) Filed: Jul. 13, 2018

(51) Int. Cl. H01Q 1/24; H01Q 21/06; H04M 1/02; H01Q 1/38; H01Q 1/42

(52) U.S. Cl. CPC H01Q 1/243; H01Q 21/065; H01Q 5/378; H01Q 1/38; H01Q 1/42; H04M 1/0277

(57) ABSTRACT

Techniques are provided for improving the performance of a wideband antenna in a mobile device. An example of an apparatus according to the disclosure includes a first radiator formed on a first plane of a wireless device, a device cover including an inside surface formed on a second plane that is above and parallel to the first plane, and a second radiator disposed on the inside surface of the device cover, such that at least a portion the second radiator is located in an area that is orthogonal to the first radiator.

### BACKGROUND

A wireless device (e.g., a cellular phone or a smart phone) may include a transmitter and a receiver coupled to an antenna to support two-way communication, and may be composed of a housing assembly (e.g., cover). In general, the transmitter may modulate a radio frequency (RF) carrier signal with data to obtain a modulated signal, amplify the modulated signal to obtain an output RF signal having the proper power level, and transmit the output RF signal via the antenna to a base station. For data reception, the receiver may obtain a received RF signal via the antenna and may condition and process the received RF signal to recover data sent by the base station. As the radio frequency used by the wireless device increases, attenuation and absorption of the RF signal by the housing assembly may decrease the capabilities of the transmitter and the receiver.

### SUMMARY

An example of an apparatus according to the disclosure includes a first radiator formed on a first plane of a wireless device, a device cover including an inside surface formed on a second plane that is above and parallel to the first plane, and a second radiator disposed on the inside surface of the device cover, such that at least a portion the second radiator is located in an area that is orthogonal to the first radiator.

Implementations of such an apparatus may include one or more of the following features. The first radiator may be a driven element and the second radiator may be a parasitic element. A millimeter-wave module may be operably coupled to the first radiator. An air gap may exist between the first radiator and the second radiator. A distance between the first plane and the second plane may be between 0.2 mm and 0.6 mm. A plurality of support ridges may be disposed between the inside surface of the device cover and the first plane. A plurality of support columns may be disposed between the inside surface of the device cover and the first plane. The first radiator may be disposed on a printed circuit board. A center of the second radiator may be located above a center of the first radiator. The first radiator and the second radiator may include a respective plurality of patch antenna elements. The plurality of patch antenna elements may include a 2×2 array of patch antenna elements. The plurality of patch antenna elements may include a 2×4 array of patch antenna elements. The second radiator may be affixed on the inside surface of the device cover with an adhesive. The apparatus may include a third radiator formed on a third plane of the wireless device, the third plane being at an angle respective to the first plane, such that the device cover includes a second inside surface formed on a fourth plane parallel to the third plane, and a fourth radiator disposed on the second inside surface of the device cover, such that at least a portion the fourth radiator is located in an area that is orthogonal to the third radiator. The third radiator is a driven element and the fourth radiator is a parasitic element.

An example of an antenna in a wireless device for transmitting and receiving radio signals according to the disclosure includes a plurality of first radiators disposed on a printed circuit board and operably coupled to an antenna controller, a cover configured to at least partially enclose the printed circuit board and the antenna controller, and a plurality of second radiators disposed on the cover, wherein each of the plurality of second radiators is positioned above a respective one of the plurality of first radiators.

Implementations of such an antenna may include one or more of the following features. The plurality of first radiators may be driven elements and the plurality of second radiators may be passive elements. The antenna controller may be a millimeter-wave module operably coupled to the plurality of first radiators. An air gap may exist between the plurality of first radiators and the plurality of second radiators. The plurality of first radiators and the plurality of second radiators may comprise a 2×2 array. The plurality of first radiators and the plurality of second radiators may comprise a 2×4 array. The radio signals may be at a frequency of between 30 gigahertz and 300 gigahertz. Each of the plurality of first radiators and each of the plurality of second radiators may include a length dimension in a range between 0.5 mm and 3.0 mm and a width dimension in a range between 0.5 mm and 3.0 mm. A distance between each of the plurality of second radiators and the respective one of the plurality of first radiators may be between 0.2 mm and 1.0 mm. The plurality of second radiators may be disposed on an inside surface of the cover. The plurality of second radiators may be disposed on an outside surface of the cover. The plurality of second radiators may be disposed between an inside surface of the cover and an outside surface of the cover.

An example of an apparatus according to the disclosure includes a first radiating means for radiating a radio signal received from an antenna controller means in a mobile device, a cover means for protecting the first radiating means and the antenna controller means, such that at least a portion of the cover means is an external surface of the mobile device, and a second radiating means for radiating the radio signal received from the first radiating means, the second radiating means being disposed on the cover means, such that at least a portion of the second radiating means is located in an area that is orthogonal to the first radiating means.

Implementations of such an apparatus may include one or more of the following features. The antenna controller means may be configured to generate the radio signal in a range of 28 GHz to 300 GHz. The first radiating means and the second radiating means may include a respective plurality of patch antenna elements.

Items and/or techniques described herein may provide one or more of the following capabilities, as well as other capabilities not mentioned. An antenna array may be fabricated in an integrated circuit in an electronic device. A device cover may be installed over the antenna array. An array of metal radiators may be printed on an inside surface and/or an outside surface of the device cover. The number and positions of the metal radiators is based on the number and positions of the elements in the antenna array. The metal radiators reduce the reflection and refraction of signals passing through the device cover. The presence of the metal radiators on the device cover increases the gain of the antenna array. The bandwidth of the antenna array may be increased. The complexity and the thickness of the antenna array integrated circuit may be reduced. The physical dimensions of the electronic may also be reduced. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

### BRIEF DESCRIPTION OF THE DRAWINGS

FIG. 1 shows a wireless device capable of communicating with different wireless communication systems.

FIG. 2 shows a wireless device with a 2-dimensional (2-D) antenna system.

FIG. 3 shows a wireless device with a 3-dimensional (3-D) antenna system.

FIG. 4 shows an exemplary design of a patch antenna.

FIGS. 5A and 5B show a side view and top view of an example patch antenna array in a wireless device.

FIGS. 6A and 6B show an example of an air coupled superstrate antenna on a device cover.

FIGS. 7A and 7B show an example of an air coupled superstrate antenna on a device cover with support ridges.

FIGS. 8A and 8B show an example of an air coupled superstrate antenna on a device cover with support columns.

FIGS. 9A-9D show examples of air coupled superstrate antennas with various radiator positions.

FIGS. 10A and 10B show examples of air coupled superstrate antennas utilizing a device display.

FIG. 11 provides examples of patch antenna geometries.

FIGS. 12A-12E provide examples of strip-shape radiators.

### DETAILED DESCRIPTION

Techniques are discussed herein for improving the performance of a wideband antenna in a mobile device. For example, many mobile devices include millimeter-wave (MMW) modules to support higher RF frequencies (e.g., 5th Generation and/or certain Wi-Fi specifications). These modules generally include a thick and multi-layered stack-up to support wideband antennas as well as the required signal and power routings to a Radio Frequency Integrated Circuit (RFIC). Current electronic manufacturing techniques create multiple layer integrated circuits (ICs), and each layer may include a high metal density which affects the antenna performance and increases the complexity of the device/circuit layout. Additionally, once a MMW module is integrated into a mobile device, the antenna performance may be degraded further by the device's rear cover due to dielectric loading and wave reflection. In general, a device cover is a structure that is disposed around something in order to protect or conceal it. For example, a device cover may be a single unit or multi-part assembly configured to enclose the electronic components within a mobile device and thereby provide a protective barrier between the electronic components and environmental elements. For hand-held devices, such as a mobile phone, the device cover provides an external surface which may enable a user to handle or otherwise have physical contact with the mobile device without damaging the circuit elements within the mobile device.

In an example, the device cover may be used in a wideband patch antenna design. For example, the upper patch(es) of the antenna may be printed on the inner side of a rear cover with an appropriate control gap between the upper and lower patches. In this design, the overall thickness of the MMW module may be reduced. Further, since the rear cover becomes part of the antenna radiator, the gain of the antenna can be increased. Fewer layers may be needed for the module to maintain the wideband performance of the patch array. As a result, the overall thickness of the device with an integrated MMW module and the upper patches on the rear cover may enable a reduction in the form factor of the mobile device.

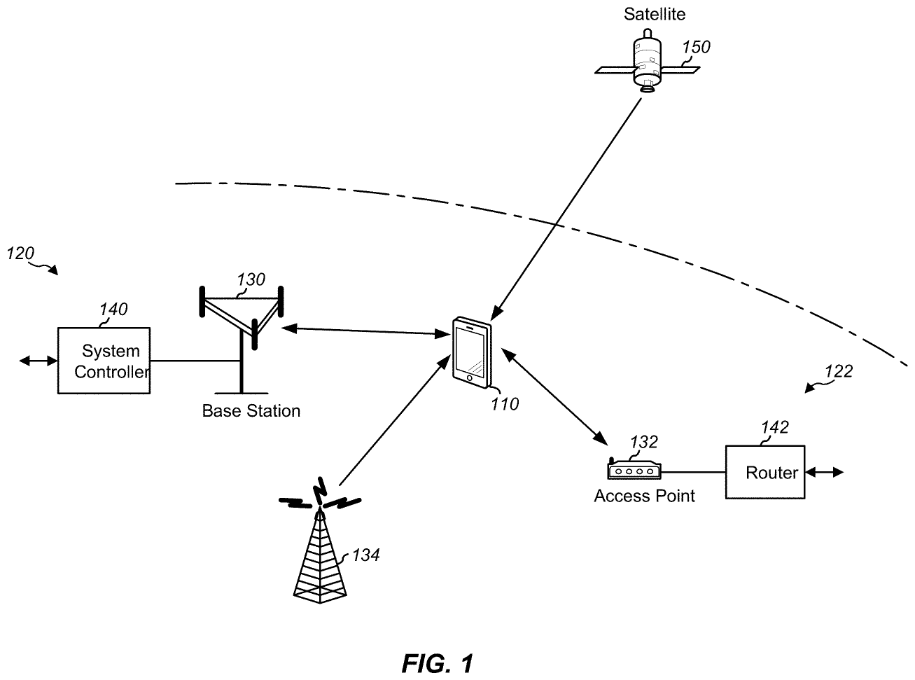

Referring to FIG. 1, a wireless device 110 capable of communicating with different wireless communication systems 120 and 122 is shown. Wireless system 120 may be a Code Division Multiple Access (CDMA) system (which may implement Wideband CDMA (WCDMA), cdma2000, or some other version of CDMA), a Global System for Mobile Communications (GSM) system, a Long Term Evolution (LTE) system, etc. Wireless system 122 may be a wireless local area network (WLAN) system, which may implement IEEE 802.11, etc. For simplicity, FIG. 1 shows wireless system 120 including one base station 130 and one system controller 140, and wireless system 122 including one access point 132 and one router 142. In general, each system may include any number of stations and any set of network entities.

Wireless device 110 may also be referred to as a user equipment (UE), a mobile device, a mobile station, a terminal, an access terminal, a subscriber unit, a station, etc. Wireless device 110 may be a cellular phone, a smart phone, a tablet, a wireless modem, a personal digital assistant (PDA), a handheld device, a laptop computer, a smartbook, a netbook, a cordless phone, a wireless local loop (WLL) station, a Bluetooth device, etc. Wireless device 110 may be equipped with any number of antennas. Further, other wireless devices (whether mobile or not) may be implemented within the systems 120 and/or 122 as the wireless device 110 and may communicate with each other and/or with the base station 130 or access point 132. For example, such other devices may include internet of thing (IoT) devices, medical devices, home entertainment and/or automation devices, etc. Multiple antennas may be used to provide better performance, to simultaneously support multiple services (e.g., voice and data), to provide diversity against deleterious path effects (e.g., fading, multipath, and interference), to support multiple-input multiple-output (MIMO) transmission to increase data rate, and/or to obtain other benefits. Wireless device 110 may be capable of communicating with wireless system 120 and/or 122. Wireless device 110 may also be capable of receiving signals from broadcast stations (e.g., a broadcast station 134). Wireless device 110 may also be capable of receiving signals from satellites (e.g., a satellite 150) in one or more global navigation satellite systems (GNSS).

In general, wireless device 110 may support communication with any number of wireless systems, which may employ radio signals including technologies such as WCDMA, cdma2000, LTE, GSM, 802.11, GPS, etc. Wireless device 110 may also support operation on any number of frequency bands.

Wireless device 110 may support operation at a very high frequency, e.g., within millimeter-wave (MMW) frequencies from 28 to 300 gigahertz (GHz). For example, wireless device 110 may operate at 60 GHz for 802.11ad. Wireless device 110 may include an antenna system to support operation at MMW frequencies. The antenna system may include a number of antenna elements, with each antenna element being used to transmit and/or receive signals. The terms “antenna” and “antenna element” are synonymous and are used interchangeably herein. Generally, each antenna element may be implemented with a patch antenna or a strip-type antenna. A suitable antenna type may be selected for use based on the operating frequency of the wireless device, the desired performance, etc. In an exemplary design, an antenna system may include a number of patch and/or strip-type antennas supporting operation at MMW frequency. Other radiator geometries and configurations may also be used. For example strip-shape antennas such as single-end fed, circular, and differential fed structures may be used.

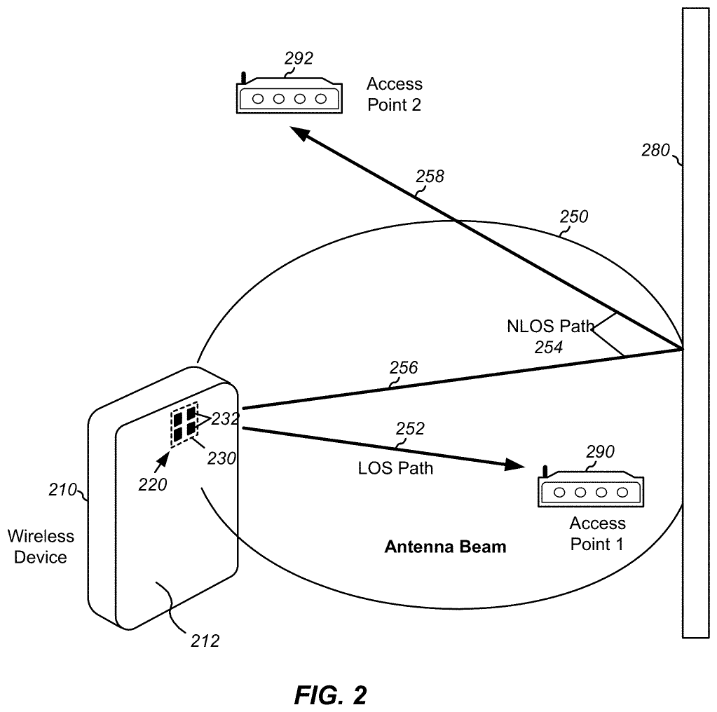

Referring to FIG. 2, an exemplary design of a wireless device 210 with a 2-D antenna system 220 is shown. In this exemplary design, antenna system 220 includes a 2×2 array 230 of four patch antennas 232 (i.e., radiators) formed on a single plane corresponding to a back surface of wireless device 210. While the antenna system 220 is visible in FIG. 2, in operation the patch array may be disposed on a PC board or other assembly located inside of a device cover 212. An antenna element may be used to transmit and/or receive signals. The antenna element may have a particular antenna beam pattern and a particular maximum antenna gain, which may be dependent on the design and implementation of the antenna element. Multiple antenna elements may be formed on the same plane and used to improve antenna gain. Higher antenna gain may be desirable at MMW frequency since (i) it is difficult to efficiently generate high power at MMW frequency and (ii) attenuation loss may be greater at MMW frequency. These limitations may be exacerbated by the presence of a back cover or other housing element or device component between a MMW antenna element and the other devices. The patch antenna array 230 has an antenna beam 250, which points in a direction that is orthogonal to the plane on which patch antennas 232 are formed in some embodiments. Wireless device 210 can transmit signals directly to other devices (e.g., access points) located within antenna beam 250 and can also receive signals directly from other devices located within antenna beam 250. Antenna beam 250 thus represents a line-of-sight (LOS) coverage of wireless device 210.

For example, an access point 290 (i.e., another device) may be located inside the LOS coverage of wireless device 210. Wireless device 210 can transmit a signal to access point 290 via a line-of-sight (LOS) path 252. Another access point 292 may be located outside the LOS coverage of wireless device 210. Wireless device 210 can transmit a signal to access point 292 via a non-line-of-sight (NLOS) path 254, which includes a direct path 256 from wireless device 210 to a wall 280 and a reflected path 258 from wall 280 to access point 292.

In general, the wireless device 210 may transmit a signal via a LOS path directly to another device located within antenna beam 250, e.g., as shown in FIG. 2. This signal may have a much lower power loss when received via the LOS path. The low power loss may allow wireless device 210 to transmit the signal at a lower power level, which may enable wireless device 210 to conserve battery power and extend battery life. The device cover 212 of the wireless device 210, however, may absorb and/or attenuate the signal and thus impact the extent at which power may be conserved. This reduction in signal caused by the device cover 212 may be more critical for longer range operations, such as with the NLOS path 254.

The wireless device 210 may transmit a signal via a NLOS path to another device located outside of antenna beam 250, e.g., as also shown in FIG. 2. This signal may have a much higher power loss when received via the NLOS path, since a large portion of the signal energy may be reflected, absorbed, and/or scattered by one or more objects in the NLOS path. Wireless device 210 may transmit the signal at a high power level in an effort to ensure that the signal can be reliably received via the NLOS path. The negative impact of the absorption and attenuation caused by the device cover 212 may require the wireless device 210 to increase the transmit power, which will negatively impact battery life.

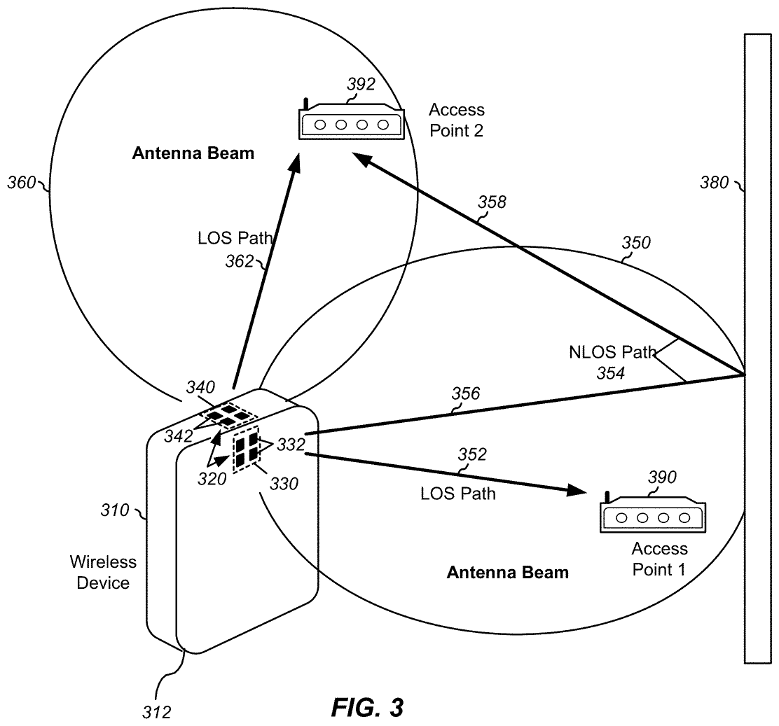

Referring to FIG. 3, an exemplary design of a wireless device 310 with a 3-D antenna system 320 is shown. In this exemplary design, antenna system 320 includes (i) a 2×2 array 330 of four patch antennas 332 formed on a first plane corresponding to the back surface of wireless device 310 and (ii) a 2×2 array 340 of four patch antennas 342 formed on a second plane corresponding to the top surface of wireless device 310. As depicted in FIG. 3, the second plane is at a 90 degree angle respective to the first plane. The 90 degree angle is exemplary only and not a limitation as other orientations between one or more antenna arrays maybe be used. The patch antenna arrays 330, 340 are disposed on the inside of a device cover 312. The antenna array 330 has an antenna beam 350, which points in a direction that is orthogonal to the first plane on which patch antennas 332 are formed in the illustrated embodiment. Antenna array 340 has an antenna beam 360, which points in a direction that is orthogonal to the second plane on which patch antennas 342 are formed in the illustrated embodiment. Antenna beams 350 and 360 thus represent the LOS coverage of wireless device 310. As described with respect to the wireless device 210 in FIG. 2, the device cover 312 may cause a decrease in the strength of transmitted signals and decrease the strength of received signals.

An access point 390 (i.e., another device) may be located inside the LOS coverage of antenna beam 350 but outside the LOS coverage of antenna beam 360. Wireless device 310 can transmit a first signal to access point 390 via a LOS path 352 within antenna beam 350. Another access point 392 may be located inside the LOS coverage of antenna beam 360 but outside the LOS coverage of antenna beam 350. Wireless device 310 can transmit a second signal to access point 392 via a LOS path 362 within antenna beam 360. Wireless device 310 can transmit a signal to access point 392 via a NLOS path 354 composed of a direct path 356 and a reflected path 358 due to a wall 380. Access point 392 may receive the signal via LOS path 362 at a higher power level than the signal via NLOS path 354. The device cover 312 may absorb the signals radiating from, or intended to be received by, the arrays 330, 340 based on the composition of the device cover (e.g., dielectric constant).

The wireless device 310 shows an exemplary design of a 3-D antenna system comprising two 2×2 antenna arrays 330 and 340 formed on two planes. In general, a 3-D antenna system may include any number of antenna elements formed on any number of planes pointing in different spatial directions (including a single plane in which multiple antenna elements radiate in different directions). The planes may or may not be orthogonal to one another. As described herein, the first antenna array 330 may include one or more driven elements (e.g., a first radiator) on a first plane and one or more passive elements (e.g., a second radiator) on a second plane located above the first plane. The second antenna array may include one or more driven elements (e.g., a third radiator) on a third plane, which is at an angle to the first plane, and one or more passive elements (e.g., a fourth radiator) on a fourth plane located with respect to the third plane, for example substantially parallel to the third plane. The device cover 312 may be a single component, or assembled from multiple components, configured to enclose and protect device components from environmental and operational factors (e.g., impact damage, water resistance, skin oils, etc. . . . ). In an example, the interior surface of the device cover 312 may form a first inside surface on the second plane and/or a second inside surface on the fourth plane.

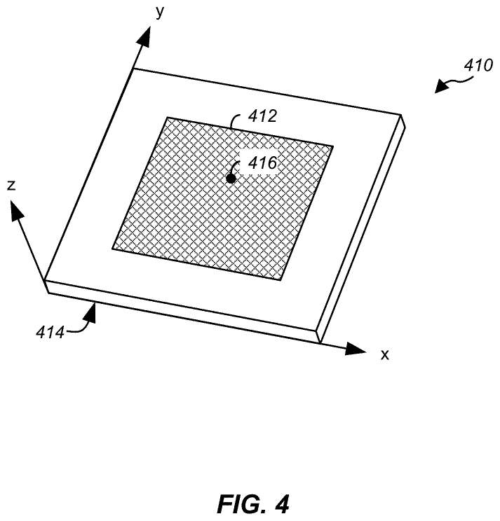

Referring to FIG. 4, an exemplary design of a patch antenna 410 suitable for MMW frequencies is shown. The patch antenna 410 includes a radiator such as a conductive patch 412 formed over a ground plane 414. In an example, the patch 412 has a dimension (e.g., 1.55×1.55 mm) selected based on the desired operating frequency. The ground plane 414 has a dimension (e.g., 2.5×2.5 mm) selected to provide the desired directivity of patch antenna 410. A larger ground plane may result in smaller backlobes. In an example, a feedpoint 416 is located near the center of patch 412 and is the point at which an output RF signal is applied to patch antenna 410 for transmission. The location of feedpoint 416 may be selected to provide the desired impedance match to a feedline. Additional patches may be assembled in an array (e.g., 1×2, 1×3, 1×4, 2×2, 2×3, 2×4, 3×3, 3×4, etc. . . . ) to further provide a desired directivity and sensitivity.

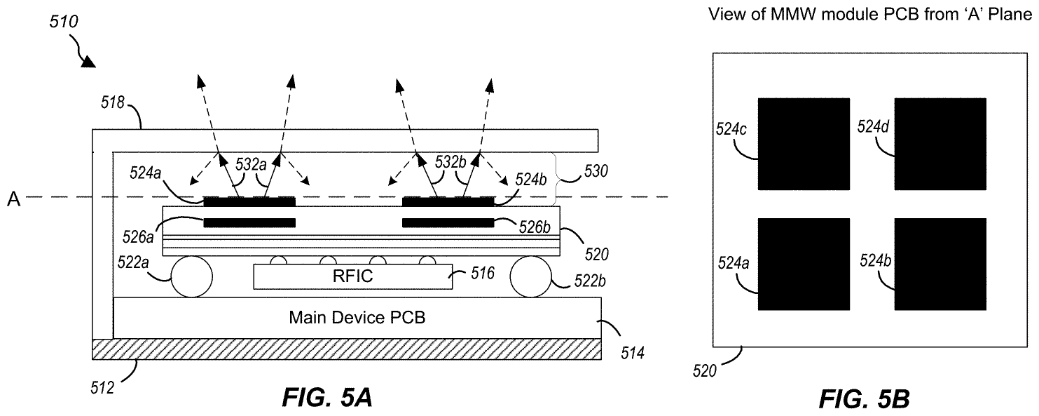

Referring to FIGS. 5A and 5B, a side view and top view of an example patch antenna array in a wireless device 510 is shown. The wireless device 510 includes a display device 512, a device cover 518, and a main device printed circuit board (PCB) 514. The device cover 518 is typically made of a plastic material such as polycarbonate or polyurethane. In some devices, the cover may be constructed of a glass or a ceramic structure. Other non-conductive materials are also used for device covers. A MMW module PCB 520 is operably coupled to the main device PCB 514 via one or more ball grid array (BGA) conductors 522a-b. The MMW module PCB 520 may include a plurality of patches 524a-d and corresponding passive patches 526a-b to form a wideband antenna. In general, a stack of patches (e.g., 524a, 526a) may include an actively driven element and one or more passive or parasitic elements. The MMW module PCB 520 also includes signal and ground layers which further increase the thickness (e.g., height) of the PCB 520. An integrated circuit (RFIC) 516 is mounted to the MMW module PCB 520 and operates to adjust the power and the radiation beam patterns associated with the patch antenna array 524a-d. The RFIC 516 is an example of an antenna controller means. For example, the integrated circuit 516 may be configured to utilize phase shifters and/or hybrid antenna couplers to control the power directed to the antenna array and to control the resulting beam pattern.

In operation, the device cover 518 may create a gap 530 between the face of the patch antenna array 524a-d and the inside of the device cover 518. The radiation 532a-b emitted from each patch array element (e.g., 524a-b) is reflected and refracted by the device cover 518 due to dielectric loading and wave reflection (e.g., the reflection and refraction are shown as respective dashed lines in FIG. 5A). A plastic device cover may typically have a dielectric constant (dk) in the range of 2-5 and a dissipation factor (df) in the range of 0.001 to 0.005. Other materials such as glass may be used for the device cover 518 and may have other dielectric properties. In each case, the proximity of the device cover 518 to the patch antenna array 524a-d may detune the antenna and thus degrade the signals transmitting from, and received by, the array. The presence of the device cover 518 may also limit the bandwidth of the patch antenna array 524a-d. The level of the signal degradation may be based on the thickness and material composition of the device cover 518, as well as the size of the gap 530.

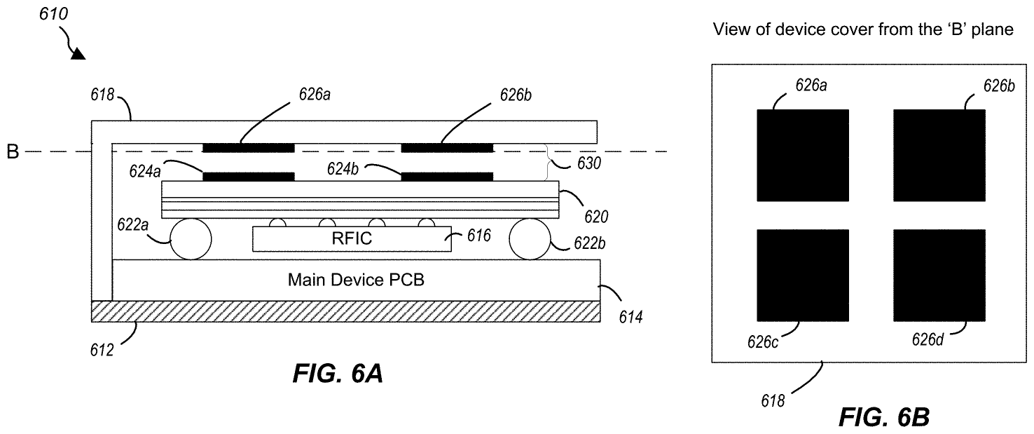

Referring to FIGS. 6A and 6B, an example of a wireless device 610 with an air coupled superstrate antenna on a device cover is shown. The device 610 includes a display device 612 and device cover 618 configured to be used in a wideband antenna design. The device 610 includes a main device PCB 614 operably coupled to a MMW module PCB 620 via one or more connectors 622a-b in a ball grid array. The MMW module PCB 620 may include a plurality of antennas, for example in a 2×2 array. Two of the four antennas are depicted in FIG. 6A as the first and second lower radiators 624a-b. The MMW module PCB 620 includes signal and ground layers operably coupled to an RF integrated circuit (RFIC) 616 mounted to the MMW module PCB 620. The integrated circuit 616 is an example of an antenna controller and may be configured to utilize phase shifters and/or hybrid antenna couplers to control the power directed to the antenna array and to control the resulting beam pattern radiating from the antenna array (e.g., the lower radiators including the first and second lower radiators 624a-b).

The device cover 618 is an example of a device cover means and may be composed of a plastic, glass, or other non-conductive material. The device cover 618 includes a plurality of metal upper radiators 626a-d disposed over the respective lower radiators (e.g., including the first and second lower radiators 624a-b). In the embodiment illustrated in FIGS. 6A-6B, the upper radiators 626a-d are disposed in a 2×2 array corresponding to the array of lower radiators 624. At least a portion of each of the upper radiators will occupy a position that is orthogonal to a respective lower radiator. In an example, the sizes of the lower and upper radiators will be approximately equal (i.e., +/−10%). The upper radiators may be disposed on the inside surface of the device cover 618 such that the center of the lower and upper radiators may be vertically aligned with one another. In operation, the upper radiators 626 may be configured as passive radiators (e.g., parasitic elements) to modify the radiation pattern of radio waves emitted by the lower radiators 624 (e.g., driven elements), for example to increase the antenna's gain. For example, the upper radiators are configured as passive resonators to absorb the radio waves from the driven elements and re-radiate them at a different phase. The waves from the different radiators interfere constructively to increase the radiation in a desired direction, and destructively to decrease the radiation in undesired directions. The size, shapes and relative positioning of the upper and lower resonators may be modified to change the overall antenna gain. The lower resonators are an example of a first radiating means for radiating a radio signal received from an antenna controller. The upper resonators are an example of a second radiating means for radiating the radio signal received from a driven element.

In some embodiments, the device cover 618 may be manufactured to be between 0.5 mm and 1.0 mm thick to provide some rigidity. The inside surface of the device cover 618 is approximately parallel (i.e., +/−5°) to the MMW module PCB 620 and the lower radiators. The thickness of the device cover 618 may vary based on the characteristics of the material used. Such a cover may have a dielectric constant (dk) in a range of 2-5 and a dissipation factor (df) in the range of 0.001 to 0.005. A parallel gap 630 between the upper and lower radiators may vary based on the frequency, radiator design, and bandwidth requirements. The size of the gap 630 may additionally or instead vary based on the material and/or thickness of the cover 618. For example, the gap 630 may be in a range between 0.2 mm and 1.0 mm for MMW applications. The upper radiators 626 may be printed or affixed to the device cover 618, for example via a laser deposition technology (LDT), a physical vapor deposition (PVD), or other printing and/or deposition technologies. In an example, the upper radiators 626 may be affixed to the device cover 618 with a thermal process, or with an adhesive material. By printing the upper radiators on the inner side of the rear cover with a proper spacing, the overall thickness of the MMW module PCB 620 may be reduced as compared to the example in FIG. 5A. Further, since the device cover 618 is part of the antenna radiator, the gain of the antenna array is increased. The removal of the passive patches 526a-b depicted in FIG. 5A provides a benefit in that fewer layers are needed for the MMW module PCB 620 to maintain the wideband antenna characteristics associated with an antenna array. As a result, the overall thickness of the wireless device 610 with the MMW module PCB 620 integrated inside may be thinner than the design depicted in FIG. 5A.

The antenna array including the lower radiators (e.g., 624a-b shown in FIG. 6A), and the upper radiators 626a-d are not limited to the 2×2 array depicted in FIGS. 6A and 6B. Other radiators and array dimensions such as 1×2, 1×3, 1×4, 2×3, 2×4, 3×3, 3×4, etc. . . . may be used. Further, the attachment of the PCB 620 and the RFIC 616 (which may be included together in a module in some embodiments) to each other and/or to the PCB 614 may be accomplished by means other than those described above and illustrated herein.

Those having skill in the art will understand that the terms “upper” and “lower” are used herein with respect to the illustrated figures for ease of description, and not to impose any requirements on the relative configuration of the radiators 624 and 626. For example, the term “lower” may refer to radiators disposed on or within a PCB, while the term “upper” may refer to radiators disposed on or within a cover or housing, irrespective of how the device 610 is facing or which portion of the housing or cover includes the “upper” radiators. While the device 610 is illustrated as having upper radiators disposed on a rear cover (e.g., a cover opposite a display) of the device 610, the air coupled superstrate antenna may be disposed on the device 610 such that the upper radiators are implemented on a top, side, bottom, back/rear, and/or front of the device 610. For example, the device cover 618 may be used in 2-D antenna systems, such as the array 230 depicted in FIG. 2. 3-D solutions may also be realized such that upper radiators may be disposed on two or more surfaces of the device cover 618, which may for example correspond with the patch antenna arrays 330, 340 in FIG. 3. More than one cover assembly (i.e., multiple parts) may be used to dispose the upper radiators above a radiator array at an appropriate gap distance (e.g., based on the operating frequencies of the respective arrays).

While the device cover is described above as comprising a plastic, glass, or other non-conductive material, those having skill in the art will understand that a conductive cover having a non-conductive portion (on which the upper radiators are disposed) may also be utilized. The cover may be implemented such the electronics and/or active components are disposed therein or thereon. In some embodiments, one or more upper radiators of the air coupled superstrate antenna are disposed on a component of the device which is neither the cover nor includes active elements or circuitry. For example, such upper radiators may be implemented on a non-conductive substrate that is separate and/or conductively isolated from the PCB on which the lower radiators are disposed. In some embodiments, the upper radiators are not (only) separated from the lower radiators by an air gap, but rather are separated by a dielectric or other material independent from the PCB on which the lower radiators are disposed. For example, with respect to FIG. 6A the gap 630 or a portion thereof may be filled with a dielectric or insulator, or such material may otherwise be disposed between the PCB 620 and the cover 618. In such embodiments, the radiator 626 may be disposed on the cover 618, or may be disposed on or in the material between the PCB 620 and the cover 618, for example such that the radiator 626 is abutting or adjacent the cover 618.

In operation, the presence of the upper radiators 626 on the device cover 618 may reduce the amount of reflection and refraction caused by the dielectric loading of the device cover material. The upper radiators 626 may increase the array gain approximately 1-1.5 dB as compared to an array depicted in FIG. 5A, which radiates directly through the device cover material.

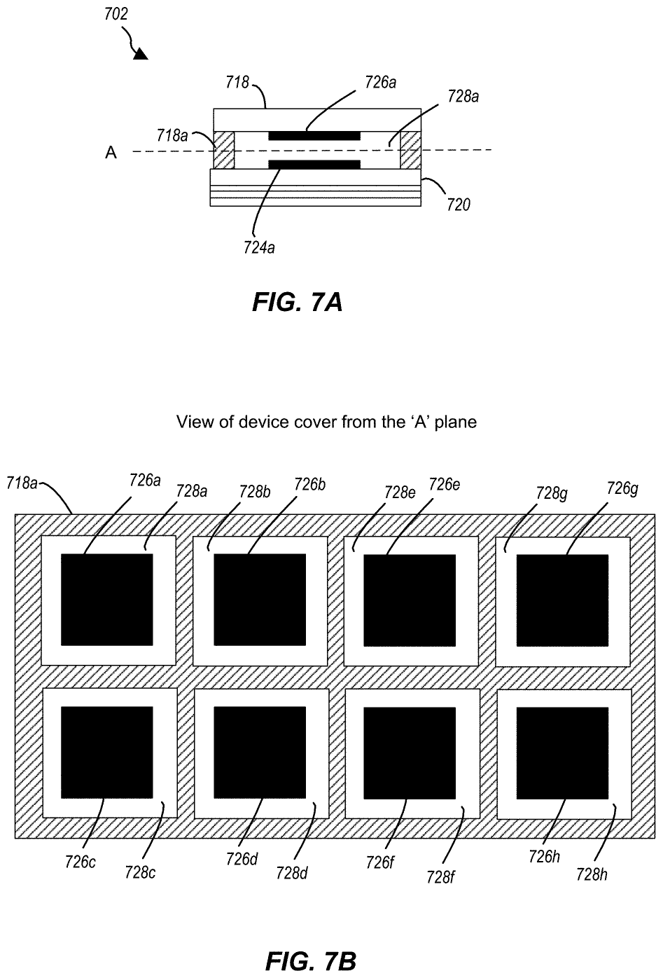

Referring to FIGS. 7A and 7B, an example of an air coupled superstrate antenna 702 on a device cover 718 with support ridges 718a is shown. The antenna 702 is an example of a single patch antenna which may be part of a larger array antenna. The antenna 702 is not limited to square patch antennas as depicted in FIGS. 7A and 7B. Other patch geometries and radiator types (e.g., strip-type antenna arrays) may be used. A lower radiator 724a may be disposed on a MMW module PCB 720. For MMW operations, the dimensions of a lower radiator 724a may have length and width dimensions in the range of 0.5 mm to 3.0 mm. The MMW module PCB 720 may be operably coupled to an RFIC and main device PCB as described above in FIGS. 5A and 6A (the RFIC and main device PCB are not shown in FIG. 7A). The device cover 718 may include one or more ridges 718a configured to maintain a parallel gap between the lower radiator 724a and a corresponding upper radiator 726a. For MMW operations, the dimensions of an upper radiator 726a may have length and width dimensions in the range of 0.5 mm to 3.0 mm. The upper radiator 726a may be positioned on the inside of the device cover 718 such that at least a portion of the upper radiator 726a is disposed over a portion of the lower radiator 724a. The device cover 718 and ridges 718a may be the same plastic or glass assembly such that the ridges 718a are the result of a milling operation performed on the device cover 718. For example, referring to FIG. 7B, the antenna 702 may be one of eight antennas in a 2×4 array. The device cover 718 may be milled to create a plurality of recesses 728a-h, which results in the ridges 718a as depicted in FIG. 7B. As an example, each of the recess 728a-h may be in the range of 2 mm to 5 mm in length and width. An upper resonator 766a-h may be printed or otherwise affixed within each of the recesses 728a-h. For example, in the 2×8 array depicted in FIG. 7B, a plurality of upper radiators 726a-h may be configured to be disposed above a 2×8 antenna array. The milling operation to form the recesses 728a-h is an example only, and not a limitation. Other manufacturing process such as injection molding may be used. In an example, the ridges 718a may be affixed to a planar surface to create the recesses 728a-h. The dimensions of the radiators, ridges, recesses, and the gap distance are exemplary only and not limitations. Other dimensions may be used based on the geometry and configuration of the corresponding radiators.

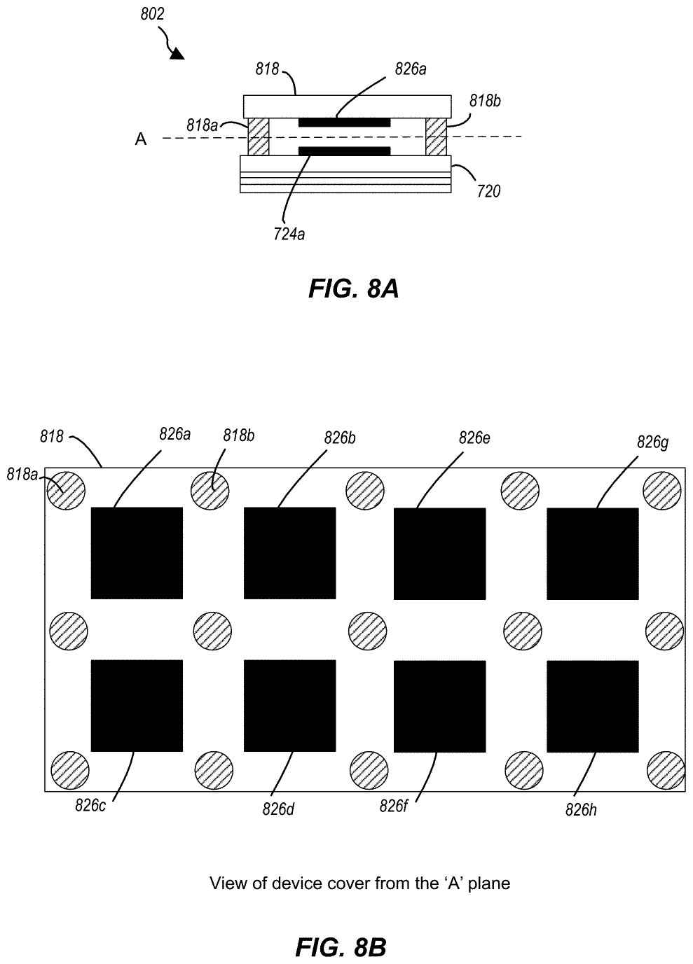

Referring to FIGS. 8A and 8B, an example of an air coupled superstrate antenna 802 on a device cover 818 with support columns 818a-b is shown. The antenna 802 is another example of a single patch antenna as described in FIG. 7A. The antenna 802, however, is not limited to square patch antennas as depicted in FIGS. 8A and 8B as other patch geometries and radiator types may be used. In this example, the device cover 818 may include one or more columns 818a-b configured to maintain a gap distance between the lower radiator 724a and a corresponding upper radiator 826a. As an example, the gap distance may be in the range of 0.2 mm to 0.6 mm. The device cover 818 and the columns 818a-b may be the same plastic, ceramic or glass assembly such as the result of injection molding or casting processes. The columns 818a-b may be separate components and affixed to the device cover 818. For example, the columns 818a-b may be plastic, ceramic, glass, Teflon®, solder balls, copper pillars, or other materials configured to provide structural support and maintain the gap between the MMW module PCB 720 and the device cover 818. Referring to FIG. 8B, the antenna 802 may be one of eight antennas in a 2×4 array. The device cover 818 may include a plurality of columns 818a-h configured to support the device cover 818 and a plurality of upper radiators 826a-h that are printed on or affixed to the device cover 818. The plurality of upper radiators 826a-h may be configured to be disposed above a 2×8 antenna array. The size, shape and locations of the columns 818a-g are examples only, and not are limitations. Other sizes, shapes, and locations may be used.

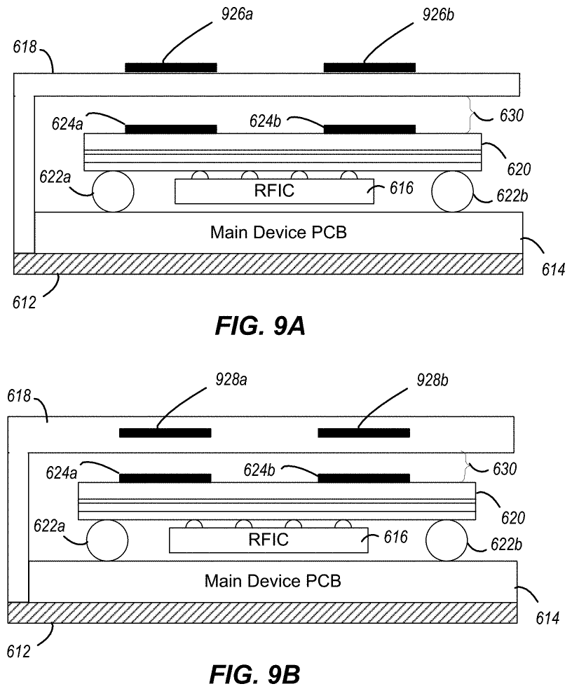

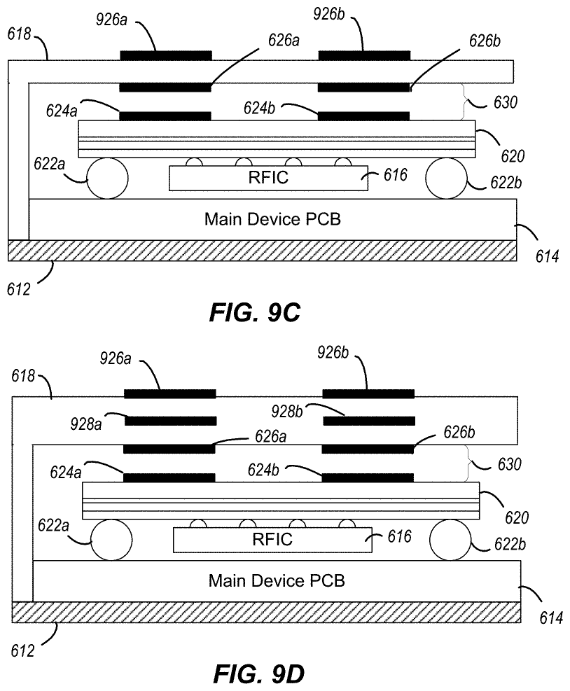

Referring to FIGS. 9A-9D, with further reference to FIGS. 6A and 6B, examples of air coupled superstrate antennas with various radiator positions are shown. A device may include the display device 612, the device cover 618, the main device PCB 614 which is operably coupled to the MMW module PCB 620 via one or more connectors 622a-b in the ball grid array. The MMW module PCB 620 may include a plurality of antennas in an array (e.g., 1×2, 2×2, 2×4, etc). For example, the first and second lower radiators 624a-b may be integrated into the MMW module PCB 620. In FIG. 9A, a first and second external upper radiators 926a-b may be printed or affixed on an exterior side of the device cover such that the each of the upper radiators are disposed over a respective lower radiator. The external upper radiators 926a-b may be printed or affixed to the exterior of the device cover 618, for example via a laser deposition technology (LDT), a physical vapor deposition (PVD), or other printing and/or deposition technologies. In an example, the external upper radiators 926a-b may be affixed to the exterior of the device cover 618 with a thermal process, or with an adhesive material. In FIG. 9B, the device cover 618 may include a first and a second embedded upper radiators 928a-b which are embedded within the back cover. For example, the embedded upper radiators 928a-b may be disposed between the interior surface and the exterior surface of the back cover and aligned with the lower radiators 624a-b as depicted in FIG. 9B. Referring to FIG. 9C, the device cover 618 may include radiators on both the internal and external surfaces. For example, the device cover 618 may include both the external upper radiators 926a-b and the upper radiators 626a-b which are printed on the respective sides of the device cover 618. The at least a portion of the upper radiators may be disposed in areas above the lower radiators 624a-b. The horizontal and vertical orientations of the radiators may be adjusted based on antenna performance requirements. In an example, referring to FIG. 9D, an antenna array may have multiple layers of radiators. The device cover 618 may include combinations of the internal upper radiators 626a-b, embedded upper radiators 928a-b, external upper radiators 926a-b, and various combinations thereof. Additional layers and support structures may also be added between the internal surface of the device cover 618 and the lower radiators 624a-b.

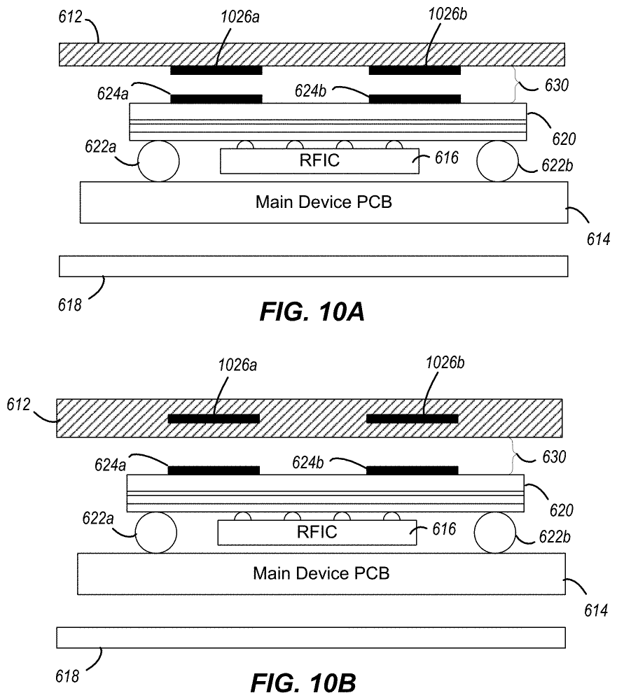

Referring to FIGS. 10A and 10B, with further reference to FIG. 6A, examples of air coupled superstrate antennas utilizing a device display are shown. A device may be assembled with an antenna array that is configured with one or more beams on the display side of the device. In this orientation, the MMW module PCB 620 may include a plurality of antennas in an array (e.g., 1×2, 1×4, 2×2, 2×4, etc) disposed near an inside surface of the display device 612. For example, the first and second lower radiators 624a-b may be disposed on the MMW module PCB 620 in an orientation that is parallel to the display device 612 as depicted in FIGS. 10A and 10B. A first and second internal upper radiators 1026a-b may be printed or affixed on the inside of the display device substrate. In an example, the display substrate may be glass and the internal upper radiators 1026a-b may be printed or affixed to the interior of the substrate, for example via a laser deposition technology (LDT), a physical vapor deposition (PVD), or other printing and/or deposition technologies. Referring to FIG. 10B, the display device 612 may include one or more embedded upper radiators 1026a-b which are integrated into the display substrate. The embedded upper radiators 1026a-b may be disposed between the exterior and interior surfaces of the display device 612 as depicted in FIG. 10B.

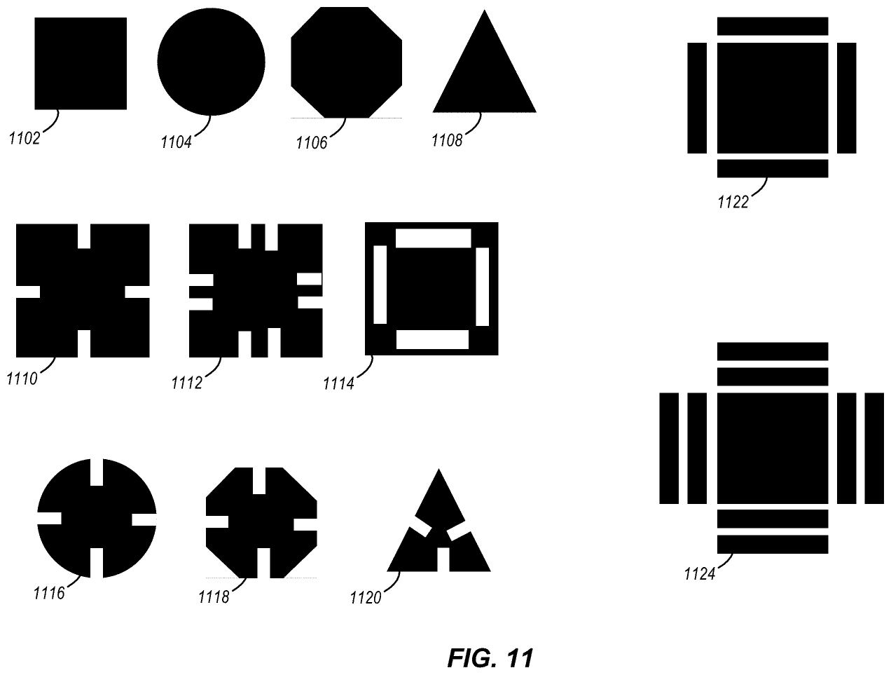

Referring to FIG. 11, with further references to FIG. 6A, examples of patch antenna geometries are shown. In general, the size and shape of a radiator may be varied based on frequency, bandwidth and beam forming requirements. The upper and lower radiators 624a-b, 626a-d in FIGS. 6A and 6B are depicted as square patches such as the square patch 1102 in FIG. 11. This square geometry is an example only and not a limitation as other radiator shapes and configurations may be used. For example, a patch antenna array may be comprised of one or more patches including other shapes such as a circle patch 1104, an octagon patch 1106, and a triangle patch 1108. Other shapes may also be used and an array may include patches with differing shapes. The properties of a patch antenna may be varied by changing the boundaries of the individual patches. For example, a square patch with single notches 1110, a square patch with multiple notches 1112, and a square with parallel notches 1114 may be used as a radiator. The square patch geometry is an example only and not a limitation as other shapes may include one or more notches such as a circle with notches 1116, an octagon with notches 1118, and a triangle with notches 1120. The shape and locations of the notches may vary. For example, the notches may be semicircles, triangles, or other shaped areas of material that are removed from the patch. A patch antenna may include one or more parasitic radiators disposed in proximity to the patch. For example, a patch with one set of parasitic radiators 1122 and a patch with two sets of parasitic radiators 1124 may be used. The geometry, number, and locations of the parasitic radiators may vary based on antenna performance requirements.

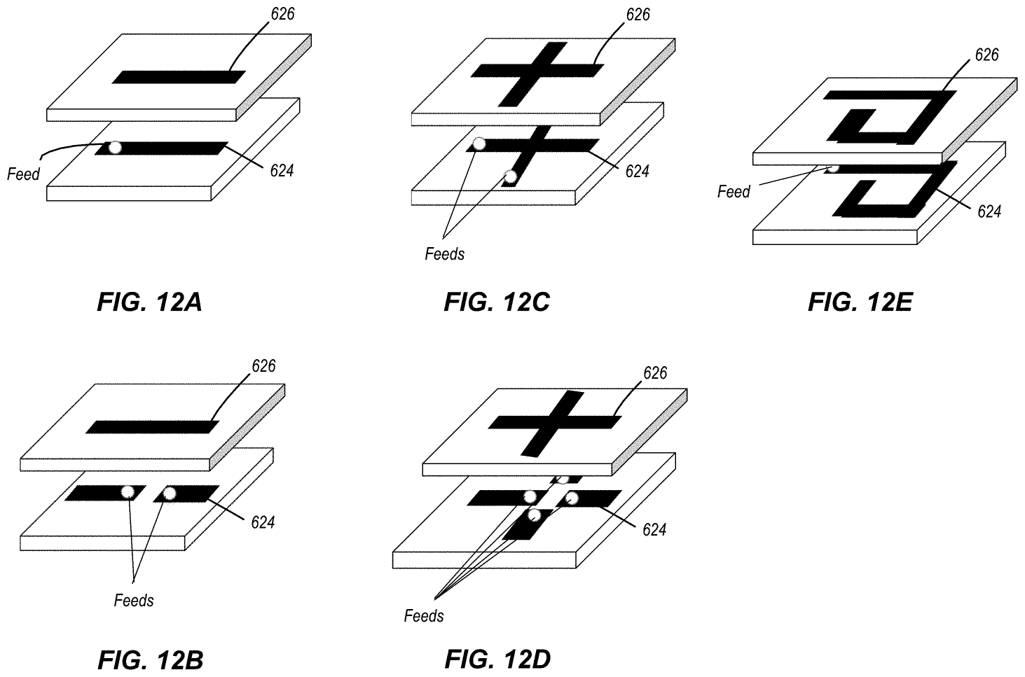

Referring to FIGS. 12A through 12E, and with further reference to FIG. 6A, examples of strip-shaped radiators are shown. The upper and lower radiators described herein are not limited to antenna patches as depicted in FIGS. 6A and 6B. The radiators may include one or more strip-shaped antennas with various orientations and feed points. While FIGS. 12A-12E depict examples with an upper and a lower radiator, multiple radiator configurations such as depicted in FIGS. 9C and 9D may also utilize strip-shaped radiators. For example, the MMW module PCB 620 may include one or more strip-shaped radiators and feed points and the device cover 618 or display 612 may include one or more strip-shaped radiators as previously described. In FIG. 12A, a first radiator 624 may include a single-ended strip with feed point that is operably coupled to the MMW module PCB 620, and a second radiator 626 may be disposed in or on the device cover 618 or display 612. In FIG. 12B, the first radiator 624 may be configured to receive a differential feed. FIG. 12C, the first radiator 624 may include single-ended strips with dual feeds, and the second radiator may include symmetric single-ended strips. In FIG. 12D, the first radiator 624 may be configured to receive dual differential feeds. The strip-shapes may be configured to form geometric shapes such as circles, spirals, s-shaped, etc. Referring to FIG. 12E, the first radiator 624 may include a single-ended strip and feed with a spiral shape (e.g., for circular polarization), and the second radiator 626 may duplicate the spiral shape in the device cover 618 or display 612 as previously described.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, as used herein, “or” as used in a list of items prefaced by “at least one of” or prefaced by “one or more of” indicates a disjunctive list such that, for example, a list of “at least one of A, B, or C,” or a list of “one or more of A, B, or C,” or “A, B, or C, or a combination thereof” means A or B or C or AB or AC or BC or ABC (i.e., A and B and C), or combinations with more than one feature (e.g., AA, AAB, ABBC, etc.).

As used herein, unless otherwise stated, a statement that a function or operation is “based on” an item or condition means that the function or operation is based on the stated item or condition and may be based on one or more items and/or conditions in addition to the stated item or condition.

Components, functional or otherwise, shown in the figures and/or discussed herein as being connected, coupled (e.g., communicatively coupled), or communicating with each other are operably coupled. That is, they may be directly or indirectly, wired and/or wirelessly, connected to enable signal transmission between them.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

Further, more than one invention may be disclosed.

What is claimed is:

1. An apparatus comprising:
a millimeter-wave module printed circuit board including a first radiator formed along a first plane of a wireless device;
a device cover including an inside surface formed on a second plane that is above and parallel to the first plane; and
a second radiator disposed on the inside surface of the device cover, wherein at least a portion the second radiator is located in an area that is above and parallel to the first radiator.

2. The apparatus of claim 1 wherein the first radiator is a driven element and the second radiator is a parasitic element.

3. (canceled)

4. The apparatus of claim 1 further comprising an air gap between the first radiator and the second radiator.

5. The apparatus of claim 1 wherein a distance between the first plane and the second plane is between 0.2 mm and 0.6 mm.

6. The apparatus of claim 1 further comprising a plurality of support ridges disposed between the inside surface of the device cover and the first plane.

7. The apparatus of claim 1 further comprising a plurality of support columns disposed between the inside surface of the device cover and the first plane.

8. (canceled)

9. The apparatus of claim 1 wherein a center of the second radiator is located above a center of the first radiator.

10. The apparatus of claim 1 wherein the first radiator and the second radiator include a respective plurality of patch antenna elements.

11. The apparatus of claim 10 wherein the plurality of patch antenna elements include a 2×2 array of patch antenna elements.

12. The apparatus of claim 10 wherein the plurality of patch antenna elements include a 2×4 array of patch antenna elements.

13. The apparatus of claim 1 wherein the second radiator is affixed on the inside surface of the device cover with an adhesive.

14. The apparatus of claim 1, further comprising:
a third radiator formed on a third plane of the wireless device, the third plane being at an angle respective to the first plane, wherein the device cover includes a second inside surface formed on a fourth plane parallel to the third plane; and
a fourth radiator disposed on the second inside surface of the device cover, wherein at least a portion the fourth radiator is located in an area that is above and parallel to the third radiator.

15. The apparatus of claim 14 wherein the third radiator is a driven element and the fourth radiator is a parasitic element.

16. An antenna in a wireless device for transmitting and receiving radio signals, comprising:
a plurality of first radiators disposed on a printed circuit board and operably coupled to an antenna controller, the plurality of first radiators and the antenna controller disposed along a first plane of the wireless device;
a cover configured to at least partially enclose the printed circuit board and the antenna controller, the cover including at least one surface formed on a second plane that is above and parallel to the first plane of the wireless device; and
a plurality of second radiators disposed on the cover, wherein each of the plurality of second radiators is positioned above a respective one of the plurality of first radiators.

17. The antenna of claim 16 wherein the plurality of first radiators are driven elements and the plurality of second radiators are passive elements.

18. The antenna of claim 16 wherein the antenna controller is a millimeter-wave module operably coupled to the plurality of first radiators.

19. The antenna of claim 16 further comprising an air gap between the plurality of first radiators and the plurality of second radiators.

20. The antenna of claim 16 wherein the plurality of first radiators and the plurality of second radiators comprise a 2×2 array.

21. The antenna of claim 16 wherein the plurality of first radiators and the plurality of second radiators comprise a 2×4 array.

22. The antenna of claim 16 wherein the radio signals are at a frequency of between 30 gigahertz and 300 gigahertz.

23. The antenna of claim 16 wherein each of the plurality of first radiators and each of the plurality of second radiators includes a length dimension in a range between 0.5 mm and 3.0 mm and a width dimension in a range between 0.5 mm and 3.0 mm.

24. The antenna of claim 16 wherein a distance between each of the plurality of second radiators and the respective one of the plurality of first radiators is between 0.2 mm and 1.0 mm.

25. The antenna of claim 16 wherein the plurality of second radiators are disposed on an inside surface of the cover.

26. The antenna of claim 16 wherein the plurality of second radiators are disposed on an outside surface of the cover.

27. The antenna of claim 16 wherein the plurality of second radiators are disposed between an inside surface of the cover and an outside surface of the cover.

28. An apparatus comprising:
a first radiating means for radiating a radio signal received from an antenna controller means in a mobile device, the first radiating means and the antenna controller means being disposed along a first plane;
a cover means for protecting the first radiating means and the antenna controller means, wherein at least a portion of the cover means is an external surface of the mobile device formed on a second plane that is above and parallel to the first plane; and
a second radiating means for radiating the radio signal received from the first radiating means, the second radiating means being disposed on the cover means, wherein at least a portion of the second radiating means is located in an area that is above and parallel to the first radiating means.

29. The apparatus of claim 28 wherein the antenna controller means is configured to generate the radio signal in a range of 28 GHz to 300 GHz.

30. The apparatus of claim 28 wherein the first radiating means and the second radiating means include a respective plurality of patch antenna elements.

31. The apparatus of claim 1 further comprising a main device printed circuit board formed along a third plane that is below and parallel to the first and second planes.

32. The apparatus of claim 31 wherein the main device printed circuit board is operably coupled to the millimeter-wave module printed board via one or more ball grid array conductors.
